(19) United States
(12) Patent Application Publication
(10) Pub. No.: US 2024/0314074 A1
(43) Pub. Date: Sep. 19, 2024

(54) DATA PROCESSING METHOD AND APPARATUS, STORAGE MEDIUM AND ELECTRONIC DEVICE

(71) Applicant: ZHEJIANG LAB, Hangzhou City (CN)

(72) Inventors: Lincheng XU, Hangzhou City (CN); Ruyun ZHANG, Hangzhou City (CN); Tao ZOU, Hangzhou City (CN); Xinbai DU, Hangzhou City (CN); Peilong HUANG, Hangzhou City (CN); Peilei WANG, Hangzhou City (CN)

(73) Assignee: ZHEJIANG LAB, Hangzhou City, ZJ (CN)

(21) Appl. No.: 18/550,104

(22) PCT Filed: Jun. 30, 2023
(86) PCT No.: PCT/CN2023/104557

§ 371 Date: Sep. 11, 2023

(30) Foreign Application Priority Data
Feb. 20, 2023 (CN) 202310178066.9

(51) Int. Cl. H04L 45/76; H04L 12/46

(52) U.S. Cl. CPC H04L 45/76; H04L 12/4645; H04L 2212/00

(57) ABSTRACT

The present disclosure relates to a data processing method and apparatus, a storage medium and an electronic device. In the method, after a switch chip receives a data frame, the data frame is analyzed by a data analysis model deployed in a data processing unit and based on an analysis result, a processing policy for the data frame is determined, and the switch chip processes the data frame based on the processing policy.

### CROSS REFERENCE TO RELATED APPLICATIONS

This application claims priority to Chinese Patent Application No. 202310178066.9 filed on Feb. 20, 2023 the entire content of which is incorporated herein by reference.

### TECHNICAL FIELD

The present disclosure relates to the field of network communication technologies and in particular to a data processing method and apparatus, a storage medium and an electronic device.

### BACKGROUND

In a data processing process, data can be forwarded by a switch of a data link layer.

In the prior arts, a conventional switch chip in a switch may analyze a received data frame based on an inherent packet protocol; and if the switch chip fails to analyze out the data frame, the data frame is sent to a data processing unit and analyzed based on pre-defined packet protocol in the data processing unit to obtain an analysis result; and based on the analysis result, a processing policy for the data frame is determined.

However, the packet protocol of the data frame analyzed out by the data processing unit is pre-defined and for a data frame without pre-defined packet protocol, no analysis result is obtained and thus no processing policy can be determined, which reduces the applicability of processing the data frames by the switch.

### SUMMARY

Embodiments of the present disclosure provide a data processing method and apparatus, a storage medium and an electronic device so as to partially solve the problems in the prior arts.

The embodiments of the present disclosure employ the following technical solution.

The present disclosure provides a data processing method, which is applied to a switch which at least includes a switch chip and a data processing unit deployed with a data analysis model. The method includes:
receiving a to-be-processed data frame by the switch chip;
sending the data frame to the data processing unit, where the data analysis model is trained by data frames generated randomly and data frames transmitted between various network devices;
analyzing, by the data analysis model, the data frame to obtain an analysis result, and determining, based on the analysis result, a processing policy for the data frame;
encapsulating, by the data processing unit, identifier information corresponding to the processing policy into the data frame to obtain a target data frame and sending the target data frame to the switch chip; and
analyzing, by the switch chip, the target data frame to obtain the processing policy, and processing, based on the processing policy, the target data frame.

In an embodiment, the switch further includes a controlling unit;
the method further includes, before sending the data frame to the data processing unit;
obtaining, by the controlling unit, the data frames transmitted between various network devices and the data frames randomly generated as data samples and determining respective processing labels corresponding to the data samples;
randomly partitioning the data samples into two sets, such that the data samples in one set are used as training data and the data samples in the other set are used as test data;
establishing, based on the training data, the data analysis model;
inputting the test data into the to-be-trained data analysis model, such that for each piece of the test data, the test data is analyzed by the data analysis model to obtain an analysis result corresponding to the test data and based on the analysis result corresponding to the test data, a to-be-optimized processing policy corresponding to the test data is predicted; and
with a target of minimizing a difference between the to-be-optimized processing policy corresponding to each piece of the test data and respective corresponding processing label, training the data analysis model.

In an embodiment, establishing, based on the training data, the data analysis model includes:
for each piece of the training data, partitioning, based on a preset byte length, the training data to obtain byte segments;
analyzing the byte segments to obtain an analysis result of each of the byte segments;
for each of the byte segments, with the analysis result of the byte segment as a node, establishing a decision tree for the byte segment, where the decision tree includes an analysis result located in the byte segment in at least one data sample, a processing label respectively corresponding to the at least one data sample, and an accumulative amount respectively corresponding to at least one processing label; and
based on the established decision tree for each of the byte segments, establishing the data analysis model.

In an embodiment, analyzing the test data to obtain the analysis result corresponding to the test data includes:
based on a preset byte length, partitioning the test data to obtain byte segments; and
analyzing the byte segments to obtain an analysis result of each of the byte segments;
where based on the analysis result corresponding to the test data, predicting the to-be-optimized processing policy corresponding to the test data includes:
for each of the byte segments of the test data, matching the analysis result of the byte segment with nodes of the decision tree of the byte segment to determine a node matching the analysis result of the byte segment as a target node; where the decision tree of the byte segment includes an analysis result located in the byte segment in at least one data sample, a processing label respectively corresponding to the at least one data sample, and an accumulative amount respectively corresponding to at least one processing label;
determining the processing label and the accumulative amount corresponding to the processing label stored in the target node as an output result of the decision tree of the byte segment; and
based on the output result of the decision tree of each of the byte segments in the test data, determining the processing label with the largest accumulative amount as the to-be-optimized processing policy corresponding to the test data.

In an embodiment, with the target of minimizing the difference between the to-be-optimized processing policy corresponding to each piece of the test data and respective corresponding processing label, training the data analysis model includes:
determining a difference between the to-be-optimized processing policy corresponding to each piece of the test data and respective corresponding processing label;
based on the difference, determining an accuracy rate that the data analysis model predicts the processing policy of each piece of the test data; and
with the target of maximizing the accuracy rate, adjusting the accumulative amount corresponding to each processing label in each decision tree included in the data analysis model to train the data analysis model.

In an embodiment, the method further includes:
after the data analysis model is trained, sending, by the controlling unit, a connection request to the data processing unit such that the data processing unit establishes connection with the controlling unit based on the connection request; and
after the data processing unit establishes connection with the controlling unit, sending, by the controlling unit, the trained data analysis model to the data processing unit, such that the data processing unit deploys the received data analysis model.

In an embodiment, the method further includes:
after the data processing unit deploys the data analysis model, returning deployment success information to the controlling unit by the data processing unit; and
after the controlling unit receives the deployment success information, sending configuration information to the switch chip by the controlling unit, such that the switch chip configures two data channels between the switch chip and the data processing unit within different virtual local area network (VLAN) scopes respectively based on the received configuration information, and configures a port for forwarding the data frame under each piece of VLAN information.

In an embodiment, analyzing the data frame to obtain the analysis result, and determining the processing policy for the data frame based on the analysis result includes:
inputting the data frame into the data analysis model, partitioning the data frame into byte segments based on a preset byte length by the data analysis model, and analyzing each byte segment to obtain an analysis result corresponding to each byte segment;
for each byte segment, matching the analysis result of the byte segment with each node in the decision tree of the byte segment to determine a node matching the analysis result of the byte segment as a matching node; where each node in the decision tree of the byte segment stores the analysis result located in the byte segment, the processing policy and the accumulative amount of the processing policy; for each node, the accumulative amount of the processing policy stored in the node represents a number of times of appearance of the processing policy corresponding to the analysis result stored in the node in all training data when the data analysis model is trained;
determining the processing policy and the accumulative amount corresponding to the processing policy stored in the matching node as an output result of the decision tree of the byte segment; and
based on the output result of the decision tree of each byte segment, determining the processing policy with the largest accumulative amount as the processing policy of the data frame.

In an embodiment, the processing policy includes rejection, redirection and forwarding.

In an embodiment, by the data processing unit, encapsulating the identifier information corresponding to the processing policy into the data frame to obtain the target data frame includes:
when the processing policy for the data frame is determined based on the data analysis model, encapsulating the identifier information of the processing policy into the data frame by the data processing unit to obtain the target data frame; and
when no processing policy for the data frame is determined based on the data analysis model, rejecting the data frame by the data processing unit.

In an embodiment, encapsulating the identifier information corresponding to the processing policy into the data frame includes:
adding the identifier information corresponding to the processing policy to a designated field of the data frame.

In an embodiment, the method further includes:
adding redirected VLAN Information to the designated field of the data frame.

In an embodiment, the designated field includes a VLAN field.

In an embodiment, adding the identifier information corresponding to the processing policy to the designated field of the data frame includes:
adding the identifier information corresponding to the processing policy to high four bits in VID of the VLAN field of the data frame.

In an embodiment, adding the redirected VLAN Information to the designated field of the data frame includes:
adding the redirected VLAN Information to low eight bits in VID of the VLAN field of the data frame.

In an embodiment, based on the processing policy, processing the target data frame includes:
when the processing policy is rejection, rejecting the target data frame;
when the processing policy is forwarding, sending the target data frame to a preconfigured designated port; and
when the processing policy is redirection, sending the target data frame to a port corresponding to the redirected VLAN Information.

The present disclosure provides a non-transitory computer readable storage medium, storing computer programs thereon, where the computer programs, when executed by a processor, cause the processor to perform the above data processing method.

The present disclosure provides an electronic device, including a processor; and a memory storing computer programs executable by the processor; where the processor is configured to execute the computer programs to perform the above data processing method.

### BRIEF DESCRIPTION OF DRAWINGS

The accompanying drawings are used to help further understanding of the present disclosure and constitute a part of the present description. The illustrative embodiments and its descriptions are used to explain the present disclosure without constituting limitation to the present disclosure.

FIG. 1 is a flowchart illustrating a data processing method according to an embodiment of the present disclosure.

FIG. 2 is a structural schematic diagram illustrating a switch according to an embodiment of the present disclosure.

FIG. 3 is a schematic diagram illustrating a frame structure of a data frame according to an embodiment of the present disclosure.

FIG. 4 is a schematic diagram illustrating a correspondence of a processing policy, identifier information and a data sample according to an embodiment of the present disclosure.

FIG. 5 is a schematic diagram illustrating a decision tree of a first byte segment according to an embodiment of the present disclosure.

FIG. 6 is a structural schematic diagram illustrating a data processing apparatus according to an embodiment of the present disclosure.

FIG. 7 is a structural schematic diagram illustrating an electronic device according to an embodiment of the present disclosure.

### DETAILED DESCRIPTION

The data processing method provided by the present disclosure aims to analyze the data frames of different packet protocols by the data analysis model and determine a processing policy for the data frames of different packet protocols, such that the switch chip processes the data frames based on the processing policies.

In order to make the object, technical solutions and advantages of the present disclosure clearer, the technical solutions of embodiments of the present disclosure will be described clearly and fully below in combination with the embodiments and corresponding drawings in the present disclosure. It is apparent that the described embodiments are merely some of embodiments of the present disclosure rather than all embodiments. Other embodiments obtained by those of ordinary skill in the art based on the embodiments in the present disclosure without making creative work shall all fall into the scope of protection of the present disclosure.

The technical solutions provided by the embodiments of the present disclosure will be detailed below in combination with drawings.

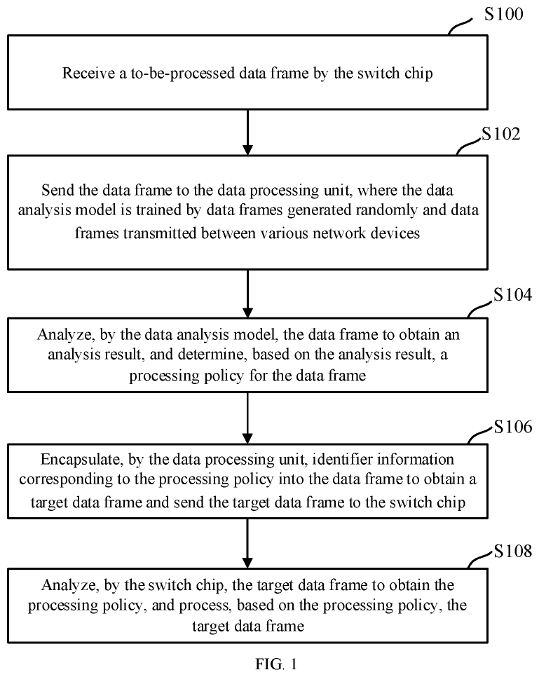

FIG. 1 is a flowchart illustrating a data processing method according to an embodiment of the present disclosure. The data processing method shown in FIG. 1 can be applied to a switch. The data processing method includes steps S100 to S108.

At step S100, a to-be-processed data frame is received by a switch chip in the switch.

In the embodiments of the present disclosure, the switch at least includes a switch chip, a controlling unit, and a data processing unit. The switch chip is used to for processing such as data frame forwarding, rejection and redirection and the like. The controlling unit is used to train a data analysis model and send configuration information for establishing communication with the data processing unit to the switch chip. The configuration information at least includes virtual local area network (VLAN) information. The data processing unit is used to deploy the data analysis model, analyze the data frame based on the data analysis model and determine a processing policy for the data frame.

Furthermore, there is a first control channel for transmitting the configuration information between the switch chip and the controlling unit, and a second control channel for transmitting the data analysis model between the controlling unit and the data processing unit; there are two data channels for transmitting the data frame between the switch chip and the data processing unit, where one data channel is used to transmit data to the data processing unit by the switch chip and the other data channel is used to transmit data to the switch chip by the data processing unit.

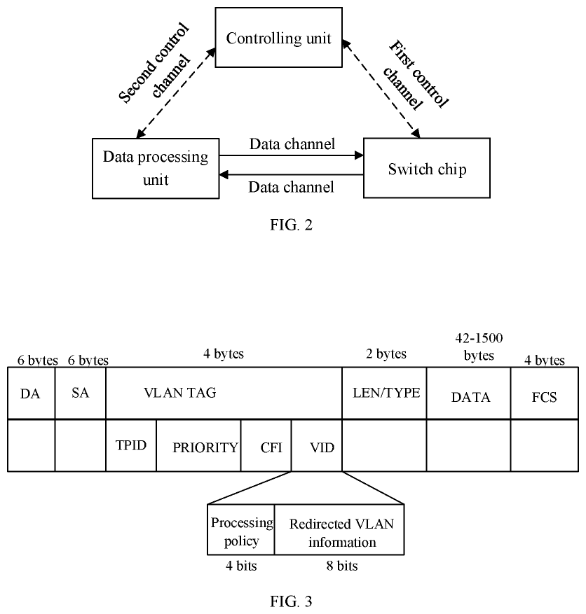

Based on the descriptions of the connection structure of the switch chip, the controlling unit and the data processing unit, a structural schematic diagram of the switch provided by the embodiments of the present disclosure is illustrated in FIG. 2.

It should be noted that, the controlling unit in the switch may run SONiC system, the switch chip may be CTC8180 chip, and the data processing unit may be central processing unit (CPU) with megacore COMe core board which can run Ubuntu system. When the controlling unit runs the SONiC system, the controlling unit may send control information carrying the configuration information to the switch chip through the first control channel in the manner of SONiC_CLI, REDIS-CLI or CTC_SHELL or the like. The controlling unit may communicate with the data processing unit through the second control channel in the following manners which at least include: Socket communication, Hypertext Transfer Protocol (HTTP) communication, Java Message Service (JMS) and WebService and the like.

In the embodiments of the present disclosure, when a user performs a service, a to-be-processed data frame may be received through the switch chip in the switch. The received to-be-processed data frame may be a data frame of conventional packet protocol, or a data frame of self-defined packet protocol. The data frame of self-defined packet protocol refers to that the field of the data frame is defined by the user.

At step S102, the data frame is sent to the data processing unit deployed with a data analysis model in the switch, where the data analysis model is trained by data frames generated randomly and data frames transmitted between various network devices.

In the embodiments of the present disclosure, after the switch chip receives the to-be-processed data frame, the switch chip may send the to-be-processed data frame to the data processing unit through a data channel between the switch chip and the data processing unit. The data analysis model is deployed in the data processing unit, and the data analysis model is trained by data frames generated randomly and data frames transmitted between various network devices. The network devices at least include: switch, router, host and the like. The data analysis model may be a support vector machine, a decision tree and a random forest model and the like. The data frames can be generated randomly by a network tester.

In addition to directly sending the to-be-processed data frame to the data processing unit, the switch chip may, after receiving the to-be-processed data frame, determine whether the switch chip can analyze the to-be-processed data frame. When the switch chip cannot analyze the received data frame, the switch chip may send the to-be-processed data frame to the data processing unit through a data channel between the switch chip and the data processing unit.

At step S104, by the data analysis model, the data frame is analyzed to obtain an analysis result and based on the analysis result, a processing policy for the data frame is determined.

After the data processing unit receives the to-be-processed data frame from the switch chip, the to-be-processed data frame may be analyzed by the data analysis model in the data processing unit to obtain an analysis result, and based on the analysis result, a processing policy for the to-be-processed data frame is determined. The processing policy may at least include: rejection, forwarding and redirection and the like.

Specifically, the to-be-processed data frame is input into the data analysis model such that the to-be-processed data frame is partitioned into byte segments by the data analysis model based on a preset byte length and the byte segments are analyzed to obtain an analysis result corresponding to each byte segment. Based on the analysis result of each byte segment in the to-be-processed data frame, a processing policy for the to-be-processed data frame is determined. The preset byte length may be 2 bytes, and the analysis result may be a character string formed of binary data format.

When the processing policy corresponding to the to-be-processed data frame is determined, for each byte segment of the to-be-processed data frame, the analysis result of the byte segment is matched with nodes in the decision tree of the byte segment to determine a node matching the analysis result of the byte segment as a matching node. The processing policy stored and an accumulative amount corresponding to the processing policy in the matching node are determined as an output result of the decision tree of the byte segment. Each node in the decision tree of the byte segment stores the analysis result located in the byte segment, the processing policy and the accumulative amount of the processing policy. For each node, the accumulative amount of the processing policy stored in the node represents a number of times of appearance of the processing policy corresponding to the analysis result stored in the node in all training data when the data analysis model is trained. The larger the accumulative amount of the processing policy is, the more trustable the processing policy is.

Based on the output result of the decision tree of each byte segment, the processing policy with the largest accumulative amount is determined as the processing policy corresponding to the to-be-processed data frame.

When the analysis result of the byte segment is matched with the nodes in the decision tree of the byte segment, for each node in the decision tree of the byte segment, the analysis result of the byte segment may be compared with an analysis result stored in the node in the decision tree of the byte segment. When the analysis result stored in the node in the decision tree of the byte segment is same as the analysis result of the byte segment, the node in the decision tree of the byte segment is determined as a candidate node. Then, based on the accumulative amount of the processing policy stored in each candidate node, a node with the largest accumulative amount of the processing policy is selected from the candidate nodes as a matching node matching the analysis result of the byte segment.

When the processing policy with the largest accumulative amount is determined as the processing policy for the to-be-processed data frame based on the output result of the decision tree of each byte segment, statistics may be carried out for the output result of the decision tree of each byte segment to determine a comprehensive accumulative amount corresponding to each processing policy and the processing policy with the largest comprehensive accumulative amount is determined as the processing policy corresponding to the to-be-processed data frame.

For example, the data frame has 10 bytes in total and the preset byte length is 2 bytes, and thus the data frame can be partitioned into five byte segments. For each byte segment, the byte segment is analyzed to obtain an analysis result corresponding to the byte segment. It is assumed that the analysis result of a first byte segment is A, the analysis result of a second byte segment is B, the analysis result of a third byte segment is C, the analysis result of a fourth byte segment is D, and the analysis result of a fifth byte segment is E. With the first byte segment, the nodes of the decision tree of the first byte segment are determined as node 1, node 2, and node 3. The node 1 stores the analysis result as A, the processing policy as rejection and the accumulative amount as 3 times; the node 2 stores the analysis result as F, the processing policy as forwarding and the accumulative amount as 2 times; the node 3 stores the analysis result as A, the processing policy as forwarding and the accumulative amount as 5 times. The candidate nodes corresponding to the analysis result A of the first byte segment are the node 1 and the node 3. Since the accumulative amount of the processing policy in the node 3 is greater than that in the node 1, the matching node matching with the analysis result of the first byte segment is the node 3, and the output result of the decision tree of the first byte segment is forwarding with the accumulative amount of forwarding being 5 times. It is assumed that the output result of the decision tree of the second byte segment is forwarding with the accumulative amount of forwarding being 3 times; the output result of the decision tree of the third byte segment is rejection with the accumulative amount of rejection being 2 times; the output result of the decision tree of the fourth byte segment is rejection with the accumulative amount of rejection being 1 times; the output result of the decision tree of the fifth byte segment is forwarding with the accumulative amount of forwarding being 2 times. In this case, for the processing policy of forwarding the comprehensive accumulative amount of the forwarding is 10 times; for the processing policy of rejection, the comprehensive accumulative amount of rejection is 3 times, and hence, the final processing policy corresponding to the to-be-processed data frame is determined as forwarding.

It is to be noted that when the data frame is analyzed using the data analysis model, it is not required to identify the specific meaning of each field of the data frame but determine the processing policy of the data frame based on the analyzed binary character string. The specific meaning of each field may at least include: packet type, source address, destination address and frame length and the like.

Furthermore, the processing policy for the to-be-processed data frame cannot be determined by the data analysis model in the data processing unit, the to-be-processed data frame is rejected by the data processing unit.

Furthermore, when it is determined by the data analysis model in the data processing unit that the processing policy for the to-be-processed data frame is rejection, the data processing unit may directly reject the to-be-processed data frame or return the data frame to the switch chip which rejects the data frame.

At step S106, by the data processing unit, identifier information corresponding to the processing policy is encapsulated into the data frame to obtain a target data frame and the target data frame is then sent to the switch chip.

At step S108, by the switch chip, the target data frame is analyzed to obtain the processing policy, and based on the processing policy, the target data frame is processed.

In the embodiments of the present disclosure, after the processing policy corresponding to the to-be-processed data frame is determined, the data frame may be re-encapsulated by the data processing unit based on the determined processing policy to obtain a re-encapsulated data frame as the target data frame. Then, the target data frame is sent to the switch chip such that the switch chip analyzes the target data frame to obtain the processing policy for the data frame. By the switch chip, the target data frame is processed based on the processing policy.

When the data frame is re-encapsulated, the identifier information corresponding to the processing policy may be encapsulated into the data frame to obtain the target data frame.

Specifically, the identifier information corresponding to the determined processing policy may be added to a designated field of the to-be-processed data frame, where the designated field may be a VLAN field. Further, each processing policy corresponds to unique identifier information, for example, the processing policy of rejection corresponds to the identifier information 0, the processing policy of forwarding correspond to the identifier information 1 and the processing policy of redirection corresponds to the identifier information 2 and the like.

When the processing policy is redirection, the identifier information corresponding to the determined processing policy and the redirected VLAN Information may be added to the designated field of the to-be-processed data frame. The VLAN information may be a VLAN value.

When the designated field is the VLAN field, the identifier information corresponding to the determined processing policy may be added to high four bits in virtual local area network identifier (VID) of the VLAN field of the data frame, and the redirected VLAN Information is added to low eight bits in the VID.

An embodiment of the present disclosure provides a schematic diagram illustrating a frame structure of a data frame as shown in FIG. 3. In FIG. 3, the high four bits of the VID of the VLAN field of the frame structure are used to represent a processing policy and the low eight bits in the VID are used to represent the redirected VLAN Information.

After the data processing units send the target data frame to the switch chip through a data channel, the switch chip receives the target data frame and analyzes the target data frame to obtain a processing policy for the target data frame. Then, by the switch chip, the target data frame is processed based on the analyzed processing policy.

Specifically, by the switch chip, the VID of the VLAN field in the target data frame is analyzed. When the high four bits of the VID are 0, it is determined that the processing policy is rejection. When the high four bits of the VID are 1, it is determined that the processing policy is forwarding. When the high four bits of the VID are 2, it is determined that the processing policy is redirection. When the processing policy is redirection, it is required to determine the information analyzed out from the low eight bits of the VID as redirected VLAN Information.

Furthermore, when the processing policy is rejection, the target data frame is rejected by the switch chip.

When the processing policy is forwarding, the target data frame is sent to a preconfigured designated port, where the designated port may be a port for forwarding the target data frame to other network devices. Further, the designated port is preconfigured by the switch chip based on the configuration information sent by the controlling unit to the switch chip.

When the processing policy is redirection, the target data frame is sent to a port corresponding to the redirected VLAN Information.

When the switch chip performs port configuration based on the configuration information, a preset port for forwarding the data frame when the processing policy is forwarding, included in the configuration information, is determined as the designated port or a port corresponding to each piece of VLAN information included in the configuration information is determined as the designated port for forwarding the data frame when the data frame is transmitted based on the VLAN information.

In a second case, when the switch chip analyzes the processing policy as forwarding, it is required to firstly determine the VLAN information based on which the target data frame is transmitted between the switch chip and the data processing unit, and then, a port corresponding to the determined VLAN information is determined as the designated port and then the target data frame is sent to the designated port.

It is noted that in the present disclosure, all actions of obtaining signal, information or data are performed under the precondition that the corresponding data protection laws and regulations of the country where the actions are performed are observed and the authorization is obtained from the owner of the corresponding apparatus.

From the method shown in FIG. 1, it can be seen that after the switch chip receives a data frame, the data frame is analyzed by the data analysis model deployed in the data processing unit and based on an analysis result, a processing policy for the data frame is determined, and then the switch chip processes the data frame based on the processing policy. Since the data analysis model is trained by data frames randomly generated and data frames transmitted between various network devices, the data analysis model can learn the capability of analyzing the data frames of different packet protocols and can quickly determine a processing policy for the data frames of different packet protocols, thereby improving the applicability of processing the data frames by the switch.

Furthermore, before the data analysis model is used, it is required to train the data analysis model.

Before the data analysis model is trained, data frames for training are to be prepared and each data frame is labeled.

By the controlling unit, the data frames transmitted between various network devices and the data frames randomly generated are obtained as data samples, and respective processing labels corresponding to the data samples are determined.

Furthermore, by a packet capture tool, the data frames transmitted between various network devices and the data frames randomly generated are obtained as data samples, where the packet capture tool at least includes: WireShark, Microsoft Network Monitor and the like. Furthermore, the data frames may be randomly generated by the flow tester, and thus, the specific meaning expressed by each field in the randomly-generated data frames is random, for example, the 12th to 13th bytes in a randomly-generated data frame 1 represent packet type, and the 12th to 13th bytes in a randomly-generated data frame 2 represent destination address. The flow tester at least includes Spirent, IXIA, Xena network performance tester and the like.

Furthermore, after the data frames are obtained by the packet capture tool, at least some data frames are filtered out from the data frames based on a preset filtering condition and the remaining data frames are determined as data samples. The preset filtering condition at least includes: at least one of filtering out the data frames with the data frame length not satisfying a preset length, filtering out the data frames with required fields being empty, and filtering out repeating data frames.

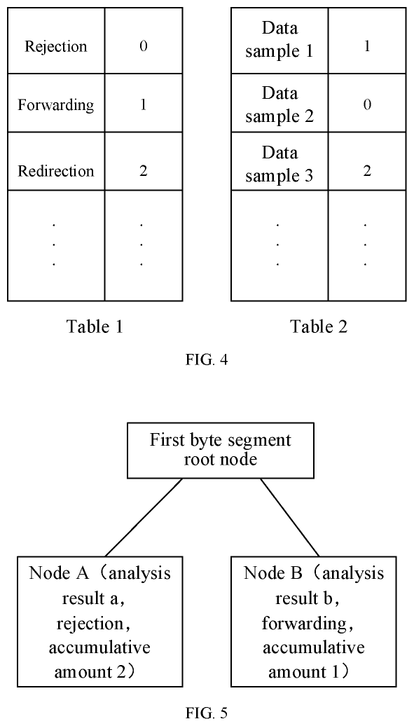

After the data samples are obtained, for each data sample, a correspondence between the data sample and the processing policy is determined and the identifier information corresponding to the processing policy is determined as a processing label of the data sample as shown in FIG. 4. In FIG. 4, it is stored in the form of table. Table 1 in FIG. 4 shows a correspondence between each processing policy and the identifier information, and Table 2 in FIG. 4 shows a mapping relationship between each data sample and the identifier information of the processing policy.

Next, the data analysis model is trained.

Firstly, the data samples are partitioned into two sets, where the data samples in one set are used as training data and the data samples in the other set are used as test data. 80% of the data samples may be determined as training data and 20% of data samples are used as test data.

Then, based on the training data, the data analysis model is established.

Specifically, for each iterative training, a part of training data may be selected randomly from the set for training the data analysis model, and then for each piece of training data in the selected part of training data, the training data is partitioned based on a preset byte length to obtain byte segments. Then, the byte segments are analyzed to obtain an analysis result of each byte segment; then, for each byte segment, with the analysis result of the byte segment as a node, a decision tree of the byte segment is established, where the decision tree includes an analysis result located in the byte segment in at least one data sample, a processing label respectively corresponding to the at least one data sample, and an accumulative amount respectively corresponding to at least one processing label. The accumulative amount corresponding to the processing label may represent a number of times that the processing label appears.

When the decision tree for the byte segment is established, for each piece of the training data, an association relationship between the analysis result of the training data in the byte segment and the processing label corresponding to the training data is established as a mapping relationship of the training data in the byte segment. When the mapping relationship of the training data in the byte segment is matched with a mapping relationship stored in existing nodes in the decision tree of the byte segment, the accumulative amount for the processing label stored in the node matching the training data in the decision tree of the byte segment is increased by 1. When the mapping relationship of the training data in the byte segment is not matched with a mapping relationship stored in existing nodes in the decision tree of the byte segment, a new node is added to the decision tree of the byte segment where the new node stores the mapping relationship of the training data in the byte segment and the accumulative amount of the processing label corresponding to the training data, and the accumulative amount of the processing label corresponding to the training data is accumulated from 1. Each node in the decision tree of the byte segment stores the mapping relationship between the analysis result of the training data in the byte segment and the processing label corresponding to the training data, and the accumulative amount corresponding to the processing label, as shown in FIG. 5.

As shown in FIG. 5, with the decision tree of the first byte segment as an example, there are training data 1, training data 2 and training data 3. The analysis result of the training data 1 in the first byte segment is a, and the processing label of the training data 1 is rejection; the analysis result of the training data 2 in the first byte segment is a, and the processing label of the training data 2 is rejection; the analysis result of the training data 3 in the first byte segment is b, and the processing label of the training data 3 is forwarding. When no node is established for the decision tree of the first byte segment from the beginning, when the training data 1 is input, a node A is directly established under the decision tree of the first byte segment, where the node A stores the analysis result a, rejection and the accumulative amount 1 of rejection; when the training data 2 is input, since the training data 2 matches the node A, the accumulative amount of rejection stored in the node A is increased by 1, namely, the accumulative amount of rejection is 2; when the training data 3 is input, since the training data 3 does not match the node A, a new node B is added under the decision tree, where the node B stores the analysis result b, forwarding and the accumulative amount 1 of forwarding.

After the decision tree for each byte segment is established, the data analysis model can be established based on the established decision tree of each byte segment, where the data analysis model may be a random forest model.

After the data analysis model is established, each piece of test data is input into the to-be-trained data analysis model such that for each piece of the test data, the test data is analyzed by the data analysis model to obtain an analysis result corresponding to the test data, and based on the analysis result corresponding to the test data, a to-be-optimized processing policy corresponding to the test data is determined. With the target of minimizing the difference between the to-be-optimized processing policy corresponding to each piece of the test data and respective corresponding processing label, the data analysis model is trained iteratively.

When the to-be-optimized processing policy corresponding to the test data is determined, the test data may be partitioned based on a preset byte length to obtain byte segments. The byte segments are analyzed to obtain an analysis result of each byte segment. Then, for each byte segment of the test data, the analysis result of the byte segment is matched with nodes in the decision tree of the byte segment to determine a node matching the analysis result of the byte segment as a target node. Then, the processing label and the accumulative amount corresponding to the processing label stored in the target node are determined as an output result of the decision tree of the byte segment. Based on the output result of the decision tree of each byte segment in the test data, the processing label with the largest accumulative amount is determined as the to-be-processed policy corresponding to the test data.

When iterative training is performed on the data analysis model with the target of minimizing the difference between the to-be-optimized processing policy corresponding to each piece of the test data and respective corresponding processing label, the difference between the to-be-optimized processing policy corresponding to each piece of the test data and respective corresponding processing label may be firstly determined, and then, based on the difference between the to-be-optimized processing policy corresponding to each piece of the test data and respective corresponding processing label, an accuracy rate that the data analysis model predicts the processing policy of each piece of test data is determined. With the target of maximizing the accurate rate, the accumulative amount corresponding to each processing label in each decision tree included in the data analysis model is adjusted to train the data analysis model.

When the accuracy rate is greater than a preset threshold, it is determined that the training for the data analysis model is completed. When the accuracy rate is not greater than the preset threshold, the iterative training for the data analysis model is continued.

Iterative training is performed for the data analysis model; a part of training data is randomly selected again from the set for training the data analysis model, and based on the selected part of training data, the data analysis model is continued to be established, and test on the established data analysis model is performed.

After the training for the data analysis model is completed, a connection request may be sent to the data processing unit through the second control channel between the controlling unit and the data processing unit. The data processing unit establishes connection with the controlling unit based on the received connection request.

For example, when the IP of the data processing unit is configured as “0.0.0.0” and a port for external service is configured as 8001, the data processing unit can normally establish connection with the controlling unit.

After the data processing unit establishes connection with the controlling unit, the trained data analysis model is sent to the data processing unit through the second control channel between the controlling unit and the data processing unit, such that the data processing unit deploys the received data analysis model.

Since the data processing unit and the controlling unit may both be written by Python language, the data processing unit and the controlling unit both can cite json library and socket library embedded in the Python.

Specifically, by the controlling unit, model parameters of the data analysis model are firstly converted into a designated data format to obtain converted parameters. The designated data format is JSON format, and the model parameters may be stored in the form of object. The model parameters may be the analysis result, the processing policy, the accumulative amount of the processing policy stored in each node and a parent node corresponding to the node in the data analysis model.

For example, the controlling unit may call json.dumps( ) interface to convert the model parameter para_result_dict into para_result_json of JASON format.

Next, after the data processing unit establishes connection with the controlling unit, a designated function is called by the controlling unit to send the converted parameters to the data processing unit. The designated function may be Socket function, and the Socket communication may be a binary communication mode based on TCP/UDP, which has the advantages of short data transmission time, high performance, high data security and the like.

After the data processing unit receives the converted parameters, the target function may be called to decode the converted parameters to obtain the model parameters of the data analysis model, and based on the model parameters, the data analysis model is deployed. The target function may be a json function.

Since the received model parameter para_result_json is in the format of JSON, it is required to call json.loads(para_result_json) to convert the model parameter para_result_json in the format of JSON into para_result_dict.

After the data processing unit deploys the data analysis model, deployment success information is returned by the data processing unit to the controlling unit. After the controlling unit receives the deployment success information, configuration information is sent to the switch chip by the controlling unit, such that the switch chip can, based on the received configuration information, configure two data channels between the switch chip and the data processing unit within different VLAN scopes, and configure a port for forwarding the data frame under each piece of VLAN information. The configuration information at least includes: indicating the switch chip to configure the data channel for the switch chip to transmit the data frame to the data processing unit and the port for receiving the data frame under same VLAN information, indicating the switch chip to configure the data channel for the data processing unit to transmit the data frame to the switch chip and the port for forwarding the data frame under same VLAN information, indicating the switch chip to monitor the data channel for the data processing unit to transmit the data frame to the switch chip, and indicating the switch chip to configure the port for forwarding the data frame when the processing policy is forwarding. It should be noted that the same VLAN information under which the data channel for the switch chip to transmit the data frame to the data processing unit and the port for receiving the data frame are configured is not overlapped with the same VLAN information under which the data channel for the data processing unit to transmit the data frame to the switch chip and the port for forwarding the data frame are configured.

After the switch chip receives the configuration information, pre-emphasis of the data channel between the switch chip and the data processing unit is configured. The pre-emphasis is a signal processing manner in which a high frequency component of an input signal is compensated at a sender to increase the stability of the channel link signal.

Then, the data channel is enabled to allow the data channel to be in an enabled state.

Next, an internal management port of the data channel by which the switch chip transmits the data frame to the data processing unit is configured to be within a first designated VLAN scope, for example, 1 to 100. For the internal management port of the data channel, a corresponding port for receiving the data frame is configured for each piece of VLAN information within the first designated VLAN scope, and the configured port is added to respective corresponding VLAN information. In other words, for each piece of VLAN information, a correspondence among the VLAN information, the port for receiving the data frame and the data channel is stored. For example, the internal management port of the data channel by which the switch chip transmits the data frame to the data processing unit and the port 1 for receiving the data frame are configured under VLAN1, and the internal management port by which the switch chip transmits the data frame to the data processing unit and the port 2 for receiving the data frame are configured under VLAN2.

Similarly, an internal management port of the data channel by which the data processing unit transmits the data frame to the switch chip is configured within a second designated VLAN scope, for example, 101 to 200. There is no overlap between the first designated VLAN scope and the second designated VLAN scope. For the internal management port of the data channel, a corresponding port for forwarding the data frame is configured for each piece of VLAN information within the second VLAN scope, and the configured port is added to respective corresponding VLAN information. In other words, for each piece of VLAN information, a correspondence among the VLAN information, the port for forwarding the data frame and the data channel is stored. For example, the internal management port of the data channel by which the data processing unit transmits the data frame to the switch chip and the port 5 for forwarding the data frame are configured under VLAN105, and the internal management port of the data channel by which the data processing unit transmits the data frame to the switch chip and the port 6 for forwarding the data frame are configured under VLAN106.

When a user performs a service, a port for forwarding the data frame is determined based on the VLAN information based on which the target data frame is transmitted between the data processing unit and the switch chip and then the target data frame is sent to the port.

The above descriptions are made on the data processing method provided by the embodiments of the present disclosure. Based on the same idea, the present disclosure further provides a corresponding apparatus, a storage medium and an electronic device.

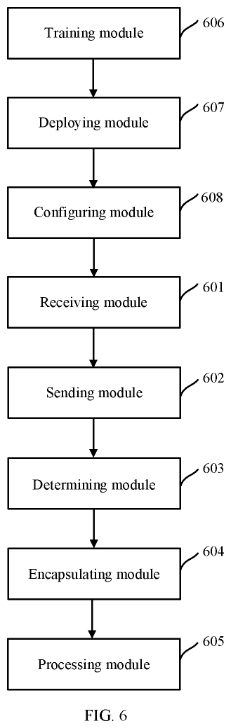

FIG. 6 is a structural schematic diagram illustrating a data processing apparatus according to an embodiment of the present disclosure. The apparatus includes: a receiving module 601, a sending module 602, a determining module 603, an encapsulating module 604, and processing module 605.

The receiving module 601, configured to receive a to-be-processed data frame by a switch chip.

The sending module 602, configured to send the data frame to a data processing unit deployed with a data analysis model, where the data analysis model is trained by data frames generated randomly and data frames transmitted between various network devices.

The determining module 603, configured to analyze the data frame based on the data analysis model to obtain an analysis result, and based on the analysis result, determine a processing policy for the data frame.

The encapsulating module 604, configured to encapsulate identifier information corresponding to the processing policy into the data frame by the data processing unit to obtain a target data frame and send the target data frame to the switch chip.

The processing module 605, configured to analyze the target data frame by the switch chip to obtain the processing policy and based on the processing policy, process the target data frame.

In an embodiment, the apparatus further includes a training module 606, a deploying module 607, and a configuring module 608.

In an embodiment, the switch may further include a controlling unit.

The training module 606 is configured to, before the data frame is sent to the data processing unit deployed with the data analysis model, obtain, by the controlling unit, the data frames transmitted between various network devices and the data frames randomly generated as data samples, and determine processing labels respectively corresponding to the data samples; randomly partition the data samples into two sets, where the data samples in one set are used as training data and the data samples in the other set are used as test data; based on the training data, establish the data analysis model; input each piece of test data into the to-be-trained data analysis model such that for each piece of test data, the test data is analyzed by the data analysis model to obtain an analysis result corresponding to the test data, and based on the analysis result corresponding to the test data, predict a to-be-optimized processing policy corresponding to the test data; and with the target of minimizing a difference between the to-be-optimized processing policy corresponding to each piece of the test data and respective corresponding processing label, train the data analysis model.

In an embodiment, the training module 606 is specifically configured to, for each piece of training data, partition the training data to obtain byte segments based on a preset byte length; analyze the byte segments to obtain an analysis result of each of the byte segments; for each of the byte segments, with the analysis result of the byte segment as a node, establish a decision tree for the byte segment, where the decision tree includes an analysis result located in the byte segment in at least one data sample, a processing label respectively corresponding to the at least one data sample, and an accumulative amount respectively corresponding to at least one processing label; and based on the established decision tree for each byte segment, establish the data analysis model.

In an embodiment, the training module 606 is specifically configured to, based on a preset byte length, partition the test data to obtain byte segments; analyze the byte segments to obtain an analysis result of each of the byte segments; for each of the byte segments of the test data, match the analysis result of the byte segment with nodes of the decision tree of the byte segment to determine a node matching the analysis result of the byte segment as a target node; determine the processing label and the accumulative amount corresponding to the processing label stored in the target node as an output result of the decision tree of the byte segment; and based on the output result of the decision tree of each of the byte segments in the test data, determine the processing label with the largest accumulative amount as the to-be-optimized processing policy corresponding to the test data.

In an embodiment, the training module 606 is specifically configured to, determine a difference between the to-be-optimized processing policy corresponding to each piece of the test data and respective corresponding processing label; based on the difference, determine an accuracy rate that the data analysis model predicts the processing policy of each piece of the test data; and with the target of maximizing the accuracy rate, adjust the accumulative amount corresponding to each processing label in each decision tree included in the data analysis model to train the data analysis model.

The deploying module 607 is configured to, after the data analysis model is trained, send, by the controlling unit, a connection request to the data processing unit such that the data processing unit establishes connection with the controlling unit based on the connection request; and after the data processing unit establishes connection with the controlling unit, send, by the controlling unit, the trained data analysis model to the data processing unit, such that the data processing unit deploys the received data analysis model.

The configuring module 608 is configured to, after the data processing unit deploys the data analysis model, return deployment success information to the controlling unit by the data processing unit; and after the controlling unit receives the deployment success information, send configuration information to the switch chip by the controlling unit, such that the switch chip configures two data channels between the switch chip and the data processing unit within different Virtual Local Area Network (VLAN) scopes respectively based on the received configuration information, and configures a port for forwarding the data frame under each piece of VLAN information.

In an embodiment, the determining module is specifically configured to input the data frame into the data analysis model, partition the data frame into byte segments based on a preset byte length by the data analysis model, and analyze each byte segment to obtain an analysis result corresponding to each byte segment; for each byte segment, match the analysis result of the byte segment with each node in the decision tree of the byte segment to determine a node matching the analysis result of the byte segment as a matching node; determine the processing policy and the accumulative amount corresponding to the processing policy stored in the matching node as an output result of the decision tree of the byte segment; and based on the output result of the decision tree of each byte segment, determine the processing policy with the largest accumulative amount as the processing policy of the data frame.

In an embodiment, the processing policy includes rejection, redirection and forwarding.

In an embodiment, the encapsulation module 604 is specifically configured to, when the processing policy for the data frame is determined based on the data analysis model, encapsulate the identifier information of the processing policy into the data frame by the data processing unit to obtain the target data frame; and when no processing policy for the data frame is determined based on the data analysis model, reject the data frame by the data processing unit.

In an embodiment, the encapsulating module 604 is specifically configured to add the identifier information corresponding to the processing policy to a designated field of the data frame.

In an embodiment, the encapsulating module 604 is specifically configured to add redirected VLAN Information to the designated field of the data frame.

In an embodiment, the designated field includes a VLAN field.

In an embodiment, the encapsulating module 604 is specifically configured to add the identifier information corresponding to the processing policy to high four bits in VID of the VLAN field of the data frame.

In an embodiment, the encapsulating module 604 is specifically configured to add the redirected VLAN Information to low eight bits in VID of the VLAN field of the data frame.

In an embodiment, the processing module 605 is specifically configured to, when the processing policy is rejection, reject the target data frame; when the processing policy is forwarding, send the target data frame to a preconfigured designated port; and when the processing policy is redirection, send the target data frame to a port corresponding to the redirected VLAN Information.

The present disclosure further provides a computer readable storage medium, storing computer programs, where the computer programs are executed by a processor to perform the data processing method shown in FIG. 1.

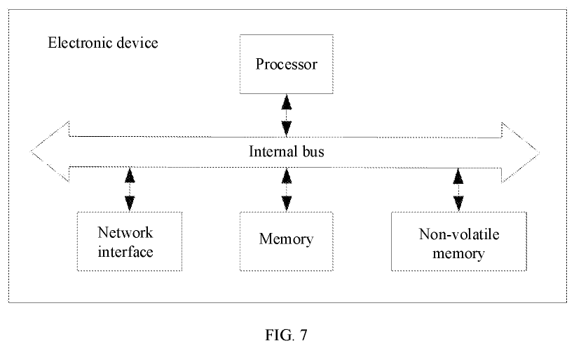

Based on the data processing method shown in FIG. 1, an embodiment of the present disclosure further provides a structural schematic diagram illustrating an electronic device shown in FIG. 7. As shown in FIG. 7, from hardware level, the electronic device includes a processor, an internal bus, a network interface, a memory and a non-volatile memory and may also include hardware required by other services. The processor reads corresponding computer programs from the non-volatile memory into the memory for running so as to achieve the data processing method shown in FIG. 1.

Of course, in addition to software implementation, the present disclosure does not preclude other implementations, for example, logic device or combination of software and hardware or the like. The execution subject for the above processing flows is not limited to each logic unit and may also be hardware or logic device.

In 1990's, whether one technical improvement is a hardware improvement (e.g., improvement on diode, transistor, switch and other circuit structures) or a software improvement (improvement on method flow) can be obviously determined. But, along with technological development, many improvements on method flows at present have been regarded as direct improvements for hardware circuit structures. Almost all of the designers program an improved method flow into a hardware circuit to obtain a corresponding hardware circuit structure. Therefore, it cannot be said that one improvement on method flow cannot be achieved by hardware entity modules. For example, Programmable Logic Device (PLD) (e.g. Field Programmable Gate Array (FPGA)) is such a integrated circuit, the logic function of which is determined by the programming of the user for the device. The designers can integrate one digital system into one sheet of PLD by programming, without requesting the chip manufacturers to design and manufacture a dedicated integrated circuit chip. Furthermore, nowadays, replacing the hand preparation of the integrated circuit chip, the programmings are mostly achieved by “logic compiler” software, which is similar to the software compiler for development and drafting the programs. But, for compiling the previous original codes, a specific programming language is to be used, which is called Hardware Description Language (HDL). The HDL includes not only one type but multiple, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, Ruby Hardware Description Language (RHDL) and the like. The mostly common at present are Very-High-Speed Integrated Circuit Hardware Description Language (VHDL) and Verilog. Those skilled in the arts should understand that as long as logic programming on the method flow and programming to the integrated circuit are performed using the above several hardware description languages, the hardware circuit for implementing the logic method flow can be easily obtained.

The controller can be implemented in any proper way, for example, the controller may determine the form of, for example, microprocessor, or processor, or computer readable medium storing computer readable program codes (e.g., software or firmware) executable on the (micro) processor, logic gate, switch, Application Specific Integrated Circuit (ASIC), programmable logic controller and embedded microcontroller. The examples of the controller may include but not limited to the following microcontrollers: ARC 625D, Atmel AT91SAM, Microchip PIC18F26K20 and Silicone Labs C8051F320, and the memory controller may also be implemented as a part of the control logic of the memory. Those skilled in the art also understand that, in addition to implementing the controller by pure computer readable program codes, logic programming may be performed on the method steps to enable the controller to achieve the same functions in the form of logic gate, switch, dedicated integrated circuit, programmable logic controller and embedded microcontroller and the like. Therefore, the controllers may be regarded as one type of hardware components, and the apparatuses for performing various functions inside the controllers can also be regarded as structures in the hardware components, or, the apparatuses for performing various functions are regarded as not only software modules for performing the methods but also structures in the hardware components.

The systems, devices, modules or units described in the above embodiments may be implemented by computer chips or entities, or by products with certain functions. A typical implementation device is a computer, and the computer, in particular form, may be a personal computer, a laptop computer, a cellular phone, a camera phone, a smart phone, a personal digital assistant, a media player, navigation equipment, an electronic mail transceiver, a tablet computer, wearable device, or combinations of any several devices of these devices.

For the convenience of description, the above-mentioned apparatus, when described, is divided into various units by function for descriptions. Of course, when the present disclosure is implemented, the functions of the units can be implemented in one or more software and/or hardware.

Those skilled in the art should understand that the embodiments of the present disclosure may be provided as methods, systems, or computer program products. Therefore, the present disclosure may determine the form of a pure hardware embodiment, a pure software embodiment, or an embodiment combining software and hardware. Furthermore, the embodiments of the present disclosure may determine the form of a computer program product implemented on one or more computer available storage mediums (including but not limited to disk memories, CD-ROM, optical storage devices, etc.) containing computer available program codes.

The present disclosure is described with reference to the flowcharts and/or block diagrams of the methods, devices (systems), and computer program products disclosed in the embodiments of the present disclosure. It should be understood that each flow and/or block in the flowcharts and/or block diagrams and combinations of flows and/or blocks in the flowcharts and/or block diagrams may be implemented by computer program instructions. These computer program instructions may be provided to a processor of a general-purpose computer, a special-purpose computer, an embedded processing machine, or other programmable data processing devices to produce a machine, so that the instructions executed by the processor or other programmable data processing device generate an apparatus for implementing functions specified in one or more flows in the flowchart and/or in one or more blocks in the block diagram.

These computer program instructions may also be stored in a computer readable memory capable of directing a computer or other programmable data processing device to operate in a particular manner, so that the instructions stored in the computer readable memory generate a manufactured product including an instruction apparatus, where the instruction apparatus implements the functions specified in one or more flows in the flowchart and/or one or more blocks in the block diagram.

These computer program instructions can also be loaded onto a computer or other programmable data processing device, so that a series of operating steps may be performed on the computer or other programmable device to generate computer-implemented processing, and thus instructions executed on the computer or other programmable device provide steps for implementing the function specified in one or more flows in the flowchart and/or one or more blocks in the block diagram.

In a typical configuration, the computing device may include one or more central processing units (CPU), an input/output interface, a network interface and a internal memory.

The internal memory may include a non-permanent memory in the computer readable storage medium, a random access memory (RAM) and/or non-volatile memory and the like, for example, Read Only Memory (ROM) or flash memory. The internal memory is an example of the computer readable medium.

The computer readable storage medium includes permanent, non-permanent, mobile and non-mobile media, which can realize information storage by any method or technology. The information may be computer readable instructions, data structures, program modules and other data. The examples of the computer storage medium include but not limited to: phase change random access memory (PRAM), a Static Random Access Memory (SRAM), a Dynamic Random Access Memory (DRAM), and other types of RAMs, Read-Only Memory (ROM), an Electrically-Erasable Programmable Read-Only Memory (EEPROM), a Flash Memory, or other memory technology, CD-ROM, digital versatile disc (DVD) or other optical storage, cassette type magnetic tape, magnetic disk storage or other magnetic storage device or other non-transmission medium for storing information accessible by computing devices. As defined in the present disclosure, the computer readable medium does not include transitory computer readable media such as modulated data signals or carriers.

It should be noted that the term “including”, “containing” or any variation thereof is intended to encompass non-exclusive inclusion, so that a process, method, article or device including a series of elements includes not only those elements but also other elements not listed explicitly or those elements inherent to such a process, method, article or device. Without more limitations, an element defined by the statement “including a . . . ” shall not be precluded to include additional same elements present in a process, method, article or device including the elements.

Persons skilled in the art shall understand that one or more embodiments of the present disclosure may be provided as methods, systems, or computer program products. Thus, one or more embodiments of the present disclosure may be adopted in the form of entire hardware embodiments, entire software embodiments or embodiments combining software and hardware. Further, one or more embodiments of the present disclosure may be adopted in the form of computer program products that are implemented on one or more computer available storage media (including but not limited to magnetic disk memory, CD-ROM, and optical memory and so on) including computer available program codes.

The present disclosure can be described in a general context of the computer executable instructions executable by the computer, for example, program module. Generally, the program module includes routine, program, object, component and data structure and the like for performing specific task or implementing a specific abstract data type. The present disclosure may also be practiced in a distributed computing environments, and in these distributed computing environments, tasks are performed by a remote processing device connected via communication network. In the distributed computing environments, the program module may be located in local or remote computer storage medium including a storage device.

Different embodiments in the present disclosure are all described in a progressive manner. Each embodiment focuses on the differences from other embodiments with those same or similar parts among the embodiments referred to each other. Particularly, since system embodiments are basically similar to the method embodiments, the system embodiments are briefly described with relevant parts referred to the descriptions of the method embodiments.

The foregoing descriptions are only embodiments of the present disclosure but not intended to limit the present disclosure. For the persons skilled in the art, various modifications and changes may be made to the present disclosure. Any modifications, equivalent substitutions, and improvements made within the spirit and principles of the disclosure shall be encompassed in the scope of protection of the present disclosure.

1. A data processing method, applied to a switch comprising a switch chip and a data processing unit deployed with a data analysis model, and comprising:
receiving a to-be-processed data frame by the switch chip;
sending the data frame to the data processing unit, wherein the data analysis model is trained by data frames generated randomly and data frames transmitted between various network devices;
analyzing, by the data analysis model, the data frame to obtain an analysis result, and determining, based on the analysis result, a processing policy for the data frame;
encapsulating, by the data processing unit, identifier information corresponding to the processing policy into the data frame to obtain a target data frame and sending the target data frame to the switch chip; and
analyzing, by the switch chip, the target data frame to obtain the processing policy, and processing, based on the processing policy, the target data frame.

2. The method of claim 1, wherein the switch further comprises a controlling unit; and the method further comprises, before sending the data frame to the data processing unit:
obtaining, by the controlling unit, the data frames transmitted between various network devices and the data frames randomly generated as data samples and determining respective processing labels corresponding to the data samples;
randomly partitioning the data samples into two sets, such that the data samples in one set are used as training data and the data samples in the other set are used as test data;
establishing, based on the training data, the data analysis model;
inputting the test data into the to-be-trained data analysis model, such that for each piece of the test data, the test data is analyzed by the data analysis model to obtain an analysis result corresponding to the test data and based on the analysis result corresponding to the test data, a to-be-optimized processing policy corresponding to the test data is predicted; and
with a target of minimizing a difference between the to-be-optimized processing policy corresponding to each piece of the test data and respective corresponding processing label, training the data analysis model.

3. The method of claim 2, wherein establishing, based on the training data, the data analysis model comprises:
for each piece of the training data, partitioning, based on a preset byte length, the training data to obtain byte segments;
analyzing the byte segments to obtain an analysis result of each of the byte segments;
for each of the byte segments, with the analysis result of the byte segment as a node, establishing a decision tree for the byte segment, wherein the decision tree comprises an analysis result located in the byte segment in at least one data sample, a processing label respectively corresponding to the at least one data sample, and an accumulative amount respectively corresponding to at least one processing label; and
based on the established decision tree for each of the byte segments, establishing the data analysis model.

4. The method of claim 2, wherein analyzing the test data to obtain the analysis result corresponding to the test data comprises:
based on a preset byte length, partitioning the test data to obtain byte segments; and
analyzing the byte segments to obtain an analysis result of each of the byte segments;
wherein based on the analysis result corresponding to the test data, predicting the to-be-optimized processing policy corresponding to the test data comprises:
for each of the byte segments of the test data, matching the analysis result of the byte segment with nodes of the decision tree of the byte segment to determine a node matching the analysis result of the byte segment as a target node; wherein the decision tree of the byte segment comprises an analysis result located in the byte segment in at least one data sample, a processing label respectively corresponding to the at least one data sample, and an accumulative amount respectively corresponding to at least one processing label;
determining the processing label and the accumulative amount corresponding to the processing label stored in the target node as an output result of the decision tree of the byte segment; and
based on the output result of the decision tree of each of the byte segments in the test data, determining the processing label with the largest accumulative amount as the to-be-optimized processing policy corresponding to the test data.

5. The method of claim 4, wherein with the target of minimizing the difference between the to-be-optimized processing policy corresponding to each piece of the test data and respective corresponding processing label, training the data analysis model comprises:
determining a difference between the to-be-optimized processing policy corresponding to each piece of the test data and respective corresponding processing label;
based on the difference, determining an accuracy rate that the data analysis model predicts the processing policy of each piece of the test data; and
with the target of maximizing the accuracy rate, adjusting the accumulative amount corresponding to each processing label in each decision tree comprised in the data analysis model to train the data analysis model.

6. The method of claim 2, further comprising:
after the data analysis model is trained, sending, by the controlling unit, a connection request to the data processing unit such that the data processing unit establishes connection with the controlling unit based on the connection request; and
after the data processing unit establishes connection with the controlling unit, sending, by the controlling unit, the trained data analysis model to the data processing unit, such that the data processing unit deploys the received data analysis model.

7. The method of claim 6, further comprising:
after the data processing unit deploys the data analysis model, returning deployment success information to the controlling unit by the data processing unit; and
after the controlling unit receives the deployment success information, sending configuration information to the switch chip by the controlling unit, such that the switch chip configures two data channels between the switch chip and the data processing unit within different virtual local area network (VLAN) scopes respectively based on the received configuration information, and configures a port for forwarding the data frame under each piece of VLAN information.

8. The method of claim 1, wherein analyzing the data frame to obtain the analysis result, and determining the processing policy for the data frame based on the analysis result comprises:
inputting the data frame into the data analysis model, partitioning the data frame into byte segments based on a preset byte length by the data analysis model, and analyzing each byte segment to obtain an analysis result corresponding to each byte segment;
for each byte segment, matching the analysis result of the byte segment with each node in the decision tree of the byte segment to determine a node matching the analysis result of the byte segment as a matching node; wherein each node in the decision tree of the byte segment stores the analysis result located in the byte segment, the processing policy and the accumulative amount of the processing policy; for each node, the accumulative amount of the processing policy stored in the node represents a number of times of appearance of the processing policy corresponding to the analysis result stored in the node in all training data when the data analysis model is trained;
determining the processing policy and the accumulative amount corresponding to the processing policy stored in the matching node as an output result of the decision tree of the byte segment; and
based on the output result of the decision tree of each byte segment, determining the processing policy with the largest accumulative amount as the processing policy of the data frame.

9. The method of claim 1, wherein the processing policy comprises rejection, redirection and forwarding.

10. The method of claim 1, wherein by the data processing unit, encapsulating the identifier information corresponding to the processing policy into the data frame to obtain the target data frame comprises:
when the processing policy for the data frame is determined based on the data analysis model, encapsulating the identifier information of the processing policy into the data frame by the data processing unit to obtain the target data frame; and
when no processing policy for the data frame is determined based on the data analysis model, rejecting the data frame by the data processing unit.

11. The method of claim 10, encapsulating the identifier information corresponding to the processing policy into the data frame comprises:
adding the identifier information corresponding to the processing policy to a designated field of the data frame.

12. The method of claim 11, further comprising:
adding redirected VLAN Information to the designated field of the data frame.

13. The method of claim 11, the designated field comprises a VLAN field.

14. The method of claim 13, wherein adding the identifier information corresponding to the processing policy to the designated field of the data frame comprises:
adding the identifier information corresponding to the processing policy to high four bits in virtual local area network identifier (VID) of the VLAN field of the data frame.

15. The method of claim 13, wherein adding the redirected VLAN Information to the designated field of the data frame comprises:
adding the redirected VLAN information to low eight bits in VID of the VLAN field of the data frame.

16. The method of claim 1, wherein based on the processing policy, processing the target data frame comprises:
when the processing policy is rejection, rejecting the target data frame;
when the processing policy is forwarding, sending the target data frame to a preconfigured designated port; and
when the processing policy is redirection, sending the target data frame to a port corresponding to the redirected VLAN Information.

17. (canceled)

18. A non-transitory computer readable storage medium, storing computer programs thereon, wherein the computer programs, when executed by a processor, cause the processor to perform operations comprising:
receiving a to-be-processed data frame;
analyzing the data frame to obtain an analysis result, and determining, based on the analysis result, a processing policy for the data frame;
encapsulating identifier information corresponding to the processing policy into the data frame to obtain a target data frame and sending the target data frame to the switch chip; and
analyzing the target data frame to obtain the processing policy, and processing, based on the processing policy, the target data frame.

19. An electronic device, comprising:
a processor; and
a memory storing computer programs executable by the processor;
wherein the processor is configured to execute the computer programs to perform operations comprising:
receiving a to-be-processed data frame;
analyzing the data frame to obtain an analysis result, and determining, based on the analysis result, a processing policy for the data frame;
encapsulating identifier information corresponding to the processing policy into the data frame to obtain a target data frame and sending the target data frame to the switch chip; and
analyzing the target data frame to obtain the processing policy, and processing, based on the processing policy, the target data frame.
